(19) United States
(12) Patent Application Publication
(10) Pub. No.: US 2025/0230084 A1
(43) Pub. Date: Jul. 17, 2025

(54) Filter Assembly

(71) Applicant: QINGDAO ECOPURE FILTER CO., LTD, Qingdao (CN)

(72) Inventor: Zhibin ZOU, Qingdao (CN)

(21) Appl. No.: 19/020,870

(22) Filed: Jan. 14, 2025

(30) Foreign Application Priority Data
Jan. 15, 2024 (CN) 202410056452.5
Jan. 15, 2024 (CN) 202420096934.9

(51) Int. Cl. C02F 9/00; C02F 1/28; C02F 1/68; C02F 101/12; C02F 101/30; C02F 101/32

(52) U.S. Cl. CPC C02F 9/00; C02F 1/283; C02F 1/687; C02F 2101/12; C02F 2101/308; C02F 2101/322; C02F 2201/005; C02F 2209/003; C02F 2209/02; C02F 2209/03; C02F 2301/043; C02F 2303/02; C02F 2307/06

(57) ABSTRACT

The disclosure provides a filter assembly. The filter assembly includes: a filtration device, wherein the filtration device includes a base and a filter portion arranged on the base, and a water inlet and a water outlet are provided on the base; an adapter structure, wherein the adapter structure is provided with a raw water inlet, a raw water outlet, a filtered water inlet and a first adapter water outlet; a rocker arm structure, wherein the rocker arm structure is provided with a connecting channel in communication with the first adapter water outlet, and a first end of the rocker arm structure is swingably connected with the first adapter water outlet; and a faucet, wherein the faucet is connected with a second end of the rocker arm structure and in communication with the connecting channel.

### CROSS-REFERENCE TO RELATED APPLICATION

The disclosure claims the priority to patent application No. 202410056452.5 filed to the Chinese Patent Office on Jan. 15, 2024 and entitled “Filter Assembly” and patent application No. 202420096934.9 filed to the Chinese Patent Office on Jan. 15, 2024 and entitled “Filter Assembly”, which are incorporated herein in their entireties by reference.

### TECHNICAL FIELD

The disclosure relates to the technical field of filter apparatuses, in particular to a filter assembly.

### BACKGROUND

A filter apparatus is designed to remove impurities and contaminants from water. When removing harmful substances from tap water, the filter apparatus adopts filtering, disinfection and softening for example, and makes the water cleaner and safer. The filter apparatus is generally applied to households, businesses and industry by providing clean water source for various purposes such as drinking water, cooking water, bathing water and the like.

A filter assembly is a core assembly in the filter apparatus. In the related art, a common filter assembly includes a substrate placed on a horizontal plane, a filter element structure arranged in the base, and a faucet connected with a water outlet of the filter element structure, and water is discharged from the faucet. The faucet is usually fixedly connected in the substrate. Users are likely to wash hands or hair sometimes when using the filter apparatus. However, the faucet in the related art cannot satisfy varying use demand from the users since it is difficult to adjust, resulting poor user experience. In conclusion, there is a problem in the art that adjustment of the faucet is difficult.

### SUMMARY

A main objective of the disclosure is to provide a filter assembly for solving the problem that a faucet is difficult to adjust in the related art.

In order to achieve the objective, the disclosure provides a filter assembly. The filter assembly includes: a filtration device, wherein the filtration device includes a base and a filter portion arranged on the base, and a water inlet and a water outlet are provided on the base; an adapter structure, wherein the adapter structure is provided with a raw water inlet, a raw water outlet, a filtered water inlet and a first adapter water outlet; the raw water inlet is capable of being in communication with an external water source, the raw water outlet is in communication with the water inlet, and the filtered water inlet is in communication with the water outlet; and the raw water inlet is in communication with the raw water outlet, and the filtered water inlet is in communication with the first adapter water outlet; a rocker arm structure, wherein the rocker arm structure is provided with a connecting channel in communication with the first adapter water outlet, and a first end of the rocker arm structure is swingably connected with the first adapter water outlet; and a faucet, wherein the faucet is connected with a second end of the rocker arm structure and in communication with the connecting channel.

Further, the faucet includes a faucet body and a connection pipe, the faucet body is arranged at a first end of the connection pipe and is arranged at an angle relative to the connection pipe, and a second end of the connection pipe is rotatably connected with the second end of the rocker arm structure and the connection pipe is arranged at an angle relative to the rocker arm structure.

Further, the rocker arm structure includes a rocker arm body, a first rotary connecting portion arranged at a first end of the rocker arm body and a second rotary connecting portion arranged at a second end of the rocker arm body, and each of the first rotary connecting portion and second rotary connecting portion is arranged at an angle relative to the rocker arm body.

Further, the adapter structure includes a third rotary connecting portion arranged at the first adapter water outlet, the first rotary connecting portion is rotatably nested with the third rotary connecting portion, and the second rotary connecting portion is rotatably nested with the second end of the connection pipe; and/or the faucet further includes a ball joint connection part, and the faucet body is rotatably connected with the connection pipe through the ball joint connection part.

Further, the faucet further includes a bubble generator connected with the second end of the rocker arm structure.

Further, the filter portion is detachably arranged on the base, the filter portion includes a housing and a cylindrical filter element arranged in the housing, a water inflow cavity in communication with the water inlet is formed between an outer surface of the cylindrical filter element and the housing, and a water outflow cavity in communication with the water outlet is formed inside the cylindrical filter element.

Further, the filter portion further includes a vitamin C (VC) ball arranged in the water outflow cavity; and/or, the cylindrical filter element includes a carbon fiber adsorption layer; and/or, the cylindrical filter element includes a filter structure, the filter structure is provided with a filter hole, and a diameter of the filter hole is less than or equal to 0.01 micrometers.

Further, the adapter structure further includes a first flow channel and a bypass valve arranged in the first flow channel; the first flow channel includes a water inflow channel, a water outflow channel and a bypass channel, a first end of the water inflow channel forms the raw water inlet, a first end of the bypass channel forms the raw water outlet, and the bypass valve is arranged at a junction of a second end of the water inflow channel, a second end of the bypass channel and a first end of the water outflow channel; the bypass valve has a purified water state and a raw water state, and when the bypass valve is in the purified water state, the bypass valve is capable of implementing communication between the water inflow channel and the bypass channel and blocking the water outflow channel; and when the bypass valve is in the raw water state, the bypass valve is capable of implementing communication between the water inflow channel and the water outflow channel and blocking the bypass channel.

Further, the adapter structure further includes a second flow channel, the second flow channel implements communication among a second end of the water outflow channel, the filtered water inlet and the first adapter water outlet, and the base includes a first check valve arranged at the water outlet, so as to limit inflow of water into the filtration device through the water outlet. Alternatively, the adapter structure further includes a second adapter water outlet, and the second flow channel includes a first channel and a second channel that are separated from each other; and the first channel implements communication between the filtered water inlet and the first adapter water outlet, and the second channel implements communication between a second end of the water outflow channel and the second adapter water outlet.

Further, the base includes a pressing member, the filter portion further includes a filter element water outlet in communication with the water outflow cavity and a valve plate that is arranged at the filter element water outlet and capable of blocking the filter element water outlet, and the pressing member is capable of pressing the valve plate, so as to implement communication between the water outlet and the water outflow cavity; and/or the filter portion further includes a filter element water inlet in communication with the water inflow cavity and a second check valve arranged at the filter element water inlet, and the second check valve is used for limiting outflow of water from the filter element water inlet.

Further, the filtration device further includes a pressure measurer, a temperature measurer and a display device, the pressure measurer and the temperature measurer are arranged at the water outlet, and the display device is arranged on an outer surface of the base and is electrically connected with the pressure measurer and the temperature measurer; and/or, the filtration device further includes a power interface and a power module, the power module is arranged in the base, and the power interface is arranged on an outer surface of the base and is electrically connected with the power module.

Further, the filter assembly further includes a connection assembly arranged between the filtration device and the adapter structure, wherein the connection assembly implements communication between the raw water outlet and the water inlet and communication between the filtered water inlet and the water outlet, and the connection assembly includes a connection member, a mounting seat body and a limiting member; the connection member includes two connection pipe bodies, and the two connection pipe bodies are in communication with the raw water outlet and the filtered water inlet respectively; the mounting seat body is arranged on the filtration device and is provided with a mounting seat body hole penetrating the mounting seat body; and the limiting member is movably arranged on the mounting seat body in a preset direction and is provided with a limiting member hole corresponding to the mounting seat body hole, the two connection pipe bodies are inserted in the mounting seat body hole and the limiting member hole, and the limiting member has a limiting position and a mounting and dismounting position; when the limiting member is located at the limiting position, the limiting member hole is in limit fit with the connection pipe body, so as to prevent the connection pipe body from being separated from the limiting member hole; and when the limiting member is at the mounting and dismounting position, the connection pipe body is capable of being separated from the limiting member hole, wherein the preset direction is arranged at an angle relative to an axis of the mounting seat body hole.

Further, a hole wall of the limiting member hole is provided with a first cambered segment and a second cambered segment, a radius of the first cambered segment is less than or equal to a radius of an outer surface of the connection pipe body, and a radius of the second cambered segment is greater than the radius of the outer surface of the connection pipe body; when the limiting member is located at the limiting position, the first cambered segment is in limit fit with the connection pipe body, so as to prevent the connection pipe body from being separated from the limiting member hole; and when the limiting member is located at the mounting and dismounting position, the second cambered segment cooperates with the connection pipe body, so as to enable the connection pipe body to be separated from the limiting member hole.

Further, the mounting seat body includes a mounting recess extending in the preset direction, and the limiting member includes an insertion plate movably arranged in the mounting recess; the limiting member hole is provided on the insertion plate, and a limiting recess is provided on the connection member; and when the limiting member is located at the limiting position, at least part, corresponding to the first cambered segment, of the insertion plate extends into the limiting recess, so as to prevent the connection pipe body from being separated from the limiting member hole.

Further, the connection assembly further includes a retainer arranged between the mounting seat body and the limiting member, and the retainer is capable of cooperating with the limiting member, so as to retain the limiting member at the limiting position.

Further, the mounting seat body includes a mounting seat body stop portion, an insertion plate stop portion is arranged on the insertion plate, and the mounting seat body stop portion is in stop fit with the insertion plate stop portion, so as to prevent the insertion plate from being separated from the mounting recess.

Further, a mounting opening is provided on the base, and the mounting seat body is inserted in the mounting opening; the mounting seat body includes two adapter pipes corresponding to the two connection pipe bodies, a first end of each adapter pipe is in communication with a corresponding connection pipe body, a second end of one adapter pipe of the two adapter pipes is in communication with the water inlet, a second end of the other adapter pipe is in communication with the water outlet, and at least part of the adapter pipe is located at an inner side of the base; and the filter assembly further includes a lock member arranged at the inner side of the base, and the lock member is connected with the adapter pipe, so as to prevent the mounting seat body from being separated outwards from the base.

By applying the technical solution of the disclosure, the base provides a mounting substrate for the filter portion, and the filter portion is used for filtering water from the external water source. The adapter structure is arranged between the rocker arm structure and the filtration device, and the raw water inlet is capable of being in communication with the external water source, so as to lead the water from the external water source into the adapter structure. The raw water inlet is in communication with the raw water outlet, and the raw water outlet is also in communication with the water inlet, such that raw water can enter the filtration device and be filtered by the filtration device, and filtered water is obtained. The filtered water enters the adapter structure through the filtered water inlet, and the filtered water inlet is in communication with the first adapter water outlet, such that the filtered water can enter the rocker arm structure from the adapter structure. The rocker arm structure is connected between the adapter structure and the faucet, such that the filtered water can be discharged from the faucet, and be used by a user. The faucet is connected with the second end of the rocker arm structure, and the first end of the rocker arm structure is swingably connected with the adapter structure, such that the rocker arm structure can swing relative to the adapter structure, the rocker arm structure can drive the faucet to swing, and a position of the faucet relative to the adapter structure can be adjusted. When the user has varying use demands, the user only needs to adjust the position of the faucet relative to the adapter structure by swinging the rocker arm structure, thereby facilitating the use of the user and improving the user experience. Thus, the technical solution of the disclosure can effectively solve the problem that the faucet is difficult to adjust in the related art.

### BRIEF DESCRIPTION OF THE DRAWINGS

Accompanying drawings are used for providing further understanding of the disclosure as a constituent part of the disclosure. Illustrative embodiments of the disclosure and their descriptions are used to explain the disclosure rather than constitute improper limitation to the disclosure. In the figures:

FIG. 1 shows a schematic diagram of a sectional view of a filter assembly according to a first embodiment of the disclosure;

FIG. 2 shows an enlarged schematic diagram of a part A of the filter assembly of FIG. 1;

FIG. 3 shows a schematic structural diagram showing a three-dimensional structure of an adapter structure, a rocker arm structure and a faucet of the filter assembly of FIG. 1;

FIG. 4 shows a schematic structural diagram showing a three-dimensional structure of a filter portion, a filter element water inflow channel and a filter element water outflow channel of the filter assembly of FIG. 1;

FIG. 5 shows a schematic diagram of a sectional view of a filtration device of the filter assembly of FIG. 1;

FIG. 6 shows a schematic diagram of a sectional view of an adapter structure of the filter assembly of FIG. 1;

FIG. 7 shows a schematic diagram of a sectional view of an adapter structure of a filter assembly according to a second embodiment of the disclosure;

FIG. 8 shows a schematic diagram of a side view of a partial structure of the filter assembly of FIG. 1, wherein the faucet is at a highest position relative to a reference position;

FIG. 9 shows a schematic diagram of a side view of a partial structure of the filter assembly of FIG. 1, wherein the faucet is at a lowest position relative to the reference position;

FIG. 10 shows a schematic diagram of a sectional view of a connection assembly of the filter assembly of FIG. 1, wherein a limiting member is at a limiting position;

FIG. 11 shows a schematic diagram of the sectional view of the connection assembly of FIG. 10, wherein the limiting member is at a mounting and dismounting position;

FIG. 12 shows a schematic structural diagram showing a three-dimensional structure of a partial structure of the connection assembly of FIG. 10;

FIG. 13 shows a schematic structural diagram showing a three-dimensional structure of a partial structure of the connection assembly of FIG. 11;

FIG. 14 shows a schematic structural diagram showing a three-dimensional structure of a connection member of the connection assembly of FIG. 10;

FIG. 15 shows a schematic structural diagram showing a three-dimensional structure of a mounting seat body of the connection assembly of FIG. 10;

FIG. 16 shows a schematic structural diagram showing a three-dimensional structure of the limiting member of the connection assembly of FIG. 10;

FIG. 17 shows a schematic structural diagram showing a three-dimensional structure of a partial structure of a housing of the filter assembly of FIG. 1; and

FIG. 18 shows a schematic structural diagram showing a three-dimensional structure of a partial structure of the filter assembly of FIG. 1.

The accompanying drawings include the following reference numerals:
d. distance between a center of a water outlet of a faucet and a reference position; a. included angle between an axis of a faucet and an axis of an adapter structure; b. preset direction;
10. filtration device; 11. base; 111. suction cup; 112. first check valve; 12. filter portion; 121. housing; 122. cylindrical filter element; 123. water inflow cavity; 124. water outflow cavity; 125. vitamin C (VC) ball; 126. carbon fiber adsorption layer; 127. filter layer; 128. filter element water outlet; 129. filter element water inlet; 13. filter element water inflow channel; 14. filter element water outflow channel; 15. mounting opening;
20. adapter structure; 211. raw water inlet; 212. raw water outlet; 221. filtered water inlet; 222. first adapter water outlet; 223. third rotary connecting portion; 224. second adapter water outlet; 23. bypass valve; 24. operation handle; 25. adapter; 26. connection member; 27. first flow channel; 271. water inflow channel; 272. water outflow channel; 273. bypass channel; 28. second flow channel;
30. rocker arm structure; 31. rocker arm body; 32. first rotary connecting portion; 33. second rotary connecting portion;
40. faucet; 41. faucet body; 42. connection pipe; 43. ball joint connection part; 431. ball head structure; 432. mounting seat; 433. connecting pipe; 44. bubble generator;
50. first diversion pipe;
60, second diversion pipe;
71. connection member; 711. connection pipe body; 712. limiting recess; 72. mounting seat body; 720. mounting seat body hole; 721. mounting recess; 7211. mounting opening; 7212. recess bottom wall; 7213. stop recess; 722. mounting seat body stop portion; 723. adapter pipe; 73. limiting member; 731. limiting member hole; 732. first cambered segment; 733. second cambered segment; 734. insertion plate; 7342. stop block; 7343. guide slope; 735. insertion plate stop portion; 74. retainer; 741. first elastic arm; 75. lock member; 76. second elastic arm; and 77. avoiding recess.

### DETAILED DESCRIPTION OF THE EMBODIMENTS

The technical solutions in embodiments of the disclosure will be clearly and completely described below with reference to accompanying drawings in the embodiments of the disclosure. Apparently, the described embodiments are merely some embodiments rather than all embodiments of the disclosure. The following description of at least one illustrative embodiment is merely illustrative actually, and is in no way intended to limit the disclosure, and its application or use. All the other embodiments derived by those skilled in the art from the embodiments of the disclosure without creative efforts should fall within the protection scope of the disclosure.

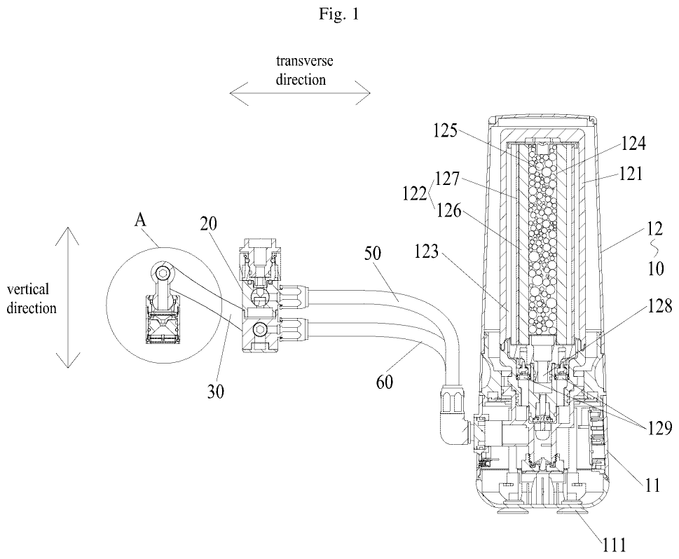

As shown in FIGS. 1-3, the disclosure provides a filter assembly. The filter assembly according to a first embodiment of the disclosure includes: a filtration device 10, an adapter structure 20, a rocker arm structure 30 and a faucet 40. The filtration device 10 includes a base 11 and a filter portion 12 arranged on the base 11, and a water inlet and a water outlet are provided on the base 11. The adapter structure 20 is provided with a raw water inlet 211, a raw water outlet 212, a filtered water inlet 221 and a first adapter water outlet 222. The raw water inlet 211 is capable of being in communication with an external water source, the raw water outlet 212 is in communication with the water inlet, and the filtered water inlet 221 is in communication with the water outlet. The raw water inlet 211 is in communication with the raw water outlet 212, and the filtered water inlet 221 is in communication with the first adapter water outlet 222. The rocker arm structure 30 is provided with a connecting channel in communication with the first adapter water outlet 222, and a first end of the rocker arm structure 30 is swingably connected with the first adapter water outlet 222. The faucet 40 is connected with a second end of the rocker arm structure 30 and in communication with the connecting channel.

By applying the technical solution of this embodiment, the base 11 provides a mounting substrate for the filter portion 12, and the filter portion 12 is used for filtering water from the external water source. The adapter structure 20 is arranged between the rocker arm structure 30 and the filtration device 10, and the raw water inlet 211 is capable of being in communication with the external water source, so as to lead the water from the external water source into the adapter structure 20. The raw water inlet 211 is in communication with the raw water outlet 212, and the raw water outlet 212 is also in communication with the water inlet, such that raw water can enter the filtration device 10 and be filtered by the filtration device 10, and filtered water is obtained. The filtered water enters the adapter structure 20 through the filtered water inlet 221, and the filtered water inlet 221 is in communication with the first adapter water outlet 222, such that the filtered water can enter the rocker arm structure 30 from the adapter structure 20. The rocker arm structure 30 is connected between the adapter structure 20 and the faucet 40, such that the filtered water can be discharged from the faucet 40, and be used by a user. The faucet 40 is connected with the second end of the rocker arm structure 30, and the first end of the rocker arm structure 30 is swingably connected with the adapter structure 20, such that the rocker arm structure 30 can swing relative to the adapter structure 20, the rocker arm structure 30 can drive the faucet 40 to swing, and a position of the faucet 40 relative to the adapter structure 20 can be adjusted. When the user has varying use demands, the user only needs to adjust the position of the faucet 40 relative to the adapter structure 20 by swinging the rocker arm structure 30, thereby facilitating the use of the user and improving the user experience. Thus, the technical solution of this embodiment can effectively solve the problem that the faucet is difficult to adjust in the related art.

In addition, in this embodiment, the filter assembly further includes a first diversion pipe 50 and a second diversion pipe 60. The first diversion pipe 50 implements communication between the raw water outlet 212 and the water inlet, and the second diversion pipe 60 implements communication between the filtered water inlet 221 and the water outlet.

In addition, compared with a solution of integrating the filter element structure into a flow channel of the faucet, in this embodiment, the filtration device 10 is arranged outside the faucet, and a volume of the filter portion 12 is not limited by a volume of the adapter structure 20 or a volume of the faucet 40. By reasonably setting the volume of the filter portion 12 by a worker, a sufficient amount of water can be purified by the filter portion 12 for unit time, and water purification efficiency of the filter portion 12 is further guaranteed.

As shown in FIGS. 1-3, the faucet 40 includes a faucet body 41 and a connection pipe 42, the faucet body 41 is arranged at a first end of the connection pipe 42 and is arranged at an angle relative to the connection pipe 42, and a second end of the connection pipe 42 is rotatably connected with the second end of the rocker arm structure 30 and the connection pipe 42 is arranged at an angle relative to the rocker arm structure 30. Specifically, the second end of the connection pipe 42 is rotatably connected with the second end of the rocker arm structure 30, such that the faucet body 41 can rotate relative to the second end of the rocker arm structure 30, and the user can adjust a position of the faucet body 41 more conveniently.

Specifically, the rocker arm structure 30 includes a rocker arm body 31, a first rotary connecting portion 32 arranged at a first end of the rocker arm body 31 and a second rotary connecting portion 33 arranged at a second end of the rocker arm body 31, and each of the first rotary connecting portion 32 and second rotary connecting portion 33 is arranged at an angle relative to the rocker arm body 31. The adapter structure 20 includes a third rotary connecting portion 223 arranged at the first adapter water outlet 222, the first rotary connecting portion 32 is rotatably nested with the third rotary connecting portion 223, and the second rotary connecting portion 33 is rotatably nested with the second end of the connection pipe 42. The faucet 40 further includes a ball joint connection part 43, and the faucet body 41 is rotatably connected with the connection pipe 42 through the ball joint connection part 43. The ball joint connection part 43 includes a ball head structure 431, a mounting seat 432 and a connecting pipe 433. The ball head structure 431 is arranged at a first end of the connecting pipe 433, the mounting seat 432 is arranged on the faucet body 41, and the mounting seat 432 is provided with a mounting recess fitting with the ball head structure 431, such that the faucet body 41 can rotate relative to the connecting pipe 433, and the user can adjust a water outflow angle of the faucet body 41. A second end of the connecting pipe 433 is connected with the first end of the connection pipe 42, the connecting pipe 433 extends in a vertical direction, and the connection pipe 42 extends in a front-back direction in FIG. 1, thus forming an L-shaped structure. The connecting pipe 433 is arranged perpendicular to the connection pipe 42, such that the faucet body 41 and the connection pipe 42 are arranged at an angle, and the faucet body 41 can discharge water in the vertical direction.

In addition, each of the first rotary connecting portion 32, the second rotary connecting portion 33 and the third rotary connecting portion 223 extends in the front-back direction in FIG. 1. The first rotary connecting portion 32 and the second rotary connecting portion 33 are connected at two ends of the rocker arm body 31 and are both perpendicular to the rocker arm body 31. That is, an axis of a rotary shaft structure formed by the first rotary connecting portion 32 and the third rotary connecting portion 223 is perpendicular to the rocker arm body 31, and an axis of a rotary shaft structure formed by the second rotary connecting portion 33 and the connection pipe 42 is perpendicular to the rocker arm body 31.

To sum up, in this embodiment, the position or the water outflow angle of the faucet body 41 is adjusted by three methods. Firstly, the first rotary connecting portion 32 is rotated relative to the third rotary connecting portion 223, such that the rocker arm body 31 swings relative to the adapter structure 20, the rocker arm body 31 can drive the faucet body 41 to swing, the position of the faucet body 41 relative to the adapter structure 20 is changed, and positions of the faucet body 41 in the vertical direction and a transverse direction are adjusted. Secondly, the connection pipe 42 is rotated relative to the second rotary connecting portion 33, such that the connection pipe 42 can drive the connecting pipe 433 to swing relative to the rocker arm body 31, the position of the faucet body 41 relative to the rocker arm body 31 is changed, and the positions of the faucet body 41 in the vertical direction and the transverse direction are adjusted. Thirdly, the faucet body 41 is rotated relative to the connecting pipe 433 around the ball head structure 431, such that the water outflow angle of the faucet body 41 is adjusted.

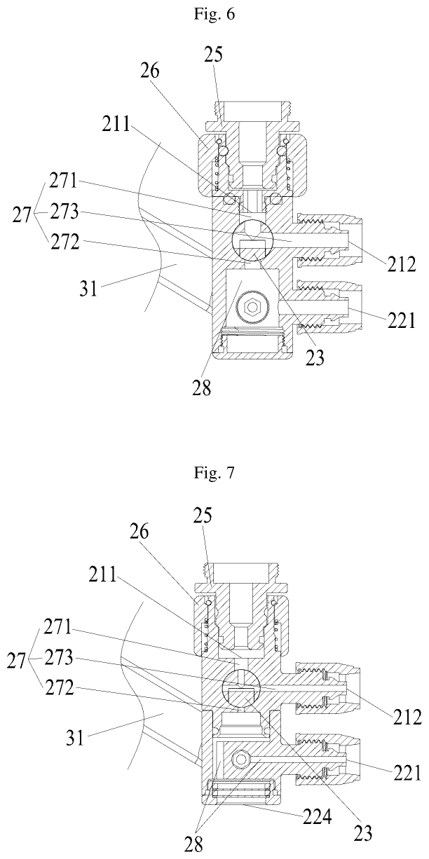

In addition, as shown in FIGS. 6 to 9, filter assembly further includes an adapter 25 and a connection member 26. The adapter 25 is arranged above the adapter structure 20 and is used for communicating with an external water pipe, so as to implement communication between the external water pipe and the raw water inlet 211. The connection member 26 has in an annular structure and is arranged between the adapter 25 and the adapter structure 20.

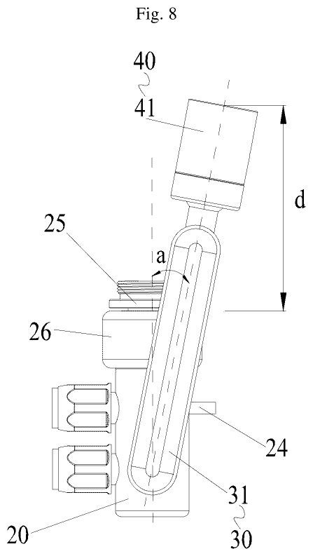

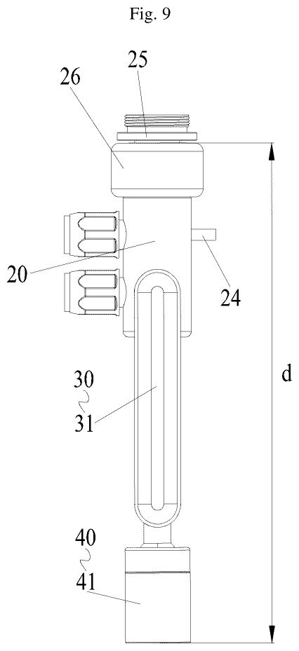

Further, when the position of the faucet body 41 is adjusted by the three methods, a size adjustment range of the faucet 40 of this embodiment in the vertical direction is as follows: an outlet of the external water source is used as a reference position (that is, an upper end of the connection member 26 is taken as the reference position, a upward is positive, and downward is negative), FIG. 8 shows a schematic diagram of the faucet 40 at a highest position, and a distance d between a center of the water outlet of the faucet 40 and the reference position is 70 mm. FIG. 9 shows a schematic diagram of the faucet 40 at a lowest position, and a distance d between the center of the water outlet of the faucet 40 and the reference position is 185 mm. Thus, an adjustable range of a height of the water outlet of the faucet 40 relative to the reference position is −185 mm to 70 mm. When the faucet 40 is located in an extreme position (that is, the highest position) above the reference position, an included angle α between an axis of the faucet 40 and an axis of the adapter structure 20 is 12°-18°.

It should be noted that, as shown in FIGS. 1 and 3, the “transverse direction” refers to the horizontal direction and a direction at an angle (for example, 0 to 5 degrees) to the horizontal direction, and the “vertical direction” refers to a direction at an angle relative to a horizontal bearing surface.

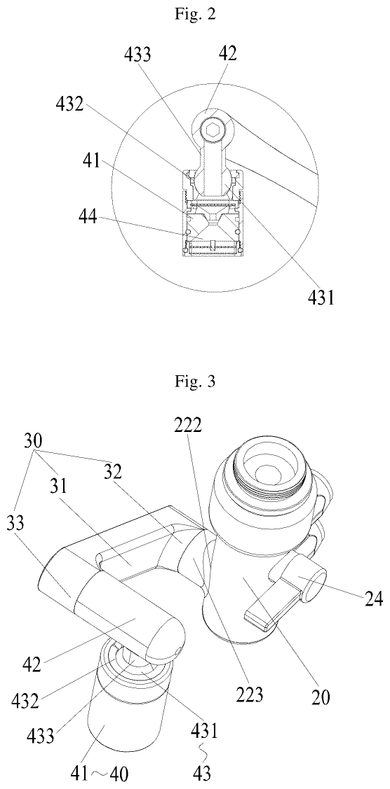

As shown in FIG. 2, the faucet 40 further includes a bubble generator 44 connected with the second end of the rocker arm structure 30. Specifically, the bubble generator 44 is arranged in the faucet body 41, and the bubble generator 44 is provided with at least one jet hole, the jet hole extends in a water flow direction, and a sectional area of the jet hole gradually increases in the water flow direction. According to a jet principle, bubbly water can be formed when water flow passes through the jet hole. A filter screen is arranged in the faucet body 41 to make bubbles in the bubbly water more uniform. In a case of a large number of bubbles in the water, due to refraction of light, the water has a milky white color when observed, and is commonly known as milky water. The bubbly water can effectively remove impurities and attachments on skin, and can remove grease and organic matters. In addition, the bubbly water can effectively reduce water loss of the skin after bathing and face washing, and improve a moisturizing capacity of the skin. The bubble generator 44 can generate a large number of hydroxyl radicals in the water. The hydroxyl radicals can kill bacteria and microorganisms to a certain extent, and can reduce the possibility of skin allergy due to the bacteria and microorganisms.

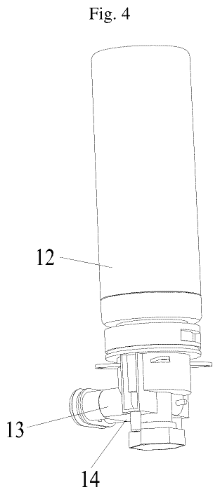

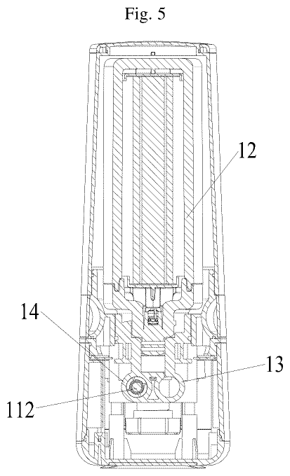

As shown in FIGS. 1, 4 and 5, the filter portion 12 is detachably arranged on the base 11, the filter portion 12 includes a housing 121 and a cylindrical filter element 122 arranged in the housing 121, a water inflow cavity 123 in communication with the water inlet is formed between an outer surface of the cylindrical filter element 122 and the housing 121, and a water outflow cavity 124 in communication with the water outlet is formed inside the cylindrical filter element 122.

Specifically, the filter portion 12 further includes a filter element water outlet 128 that is provided at a lower end of the housing 121 and in communication with the water outflow cavity 124 and a filter element water inlet 129 that is provided at the lower end of the housing 121 and in communication with the water inflow cavity 123. In addition, the filter assembly in this embodiment further includes a filter element water inflow channel 13 and a filter element water outflow channel 14 that are arranged in the base 11. The filter element water inflow channel 13 implements communication between the filter element water inlet 129 and the water inlet, and the filter element water outflow channel 14 implements communication between the filter element water outlet 128 and the water outlet. The filter element water inflow channel 13 and the filter element water outflow channel 14 are separated from each other. After entering the water inflow cavity 123 from the filter element water inlet 129, the water flows into the water outflow cavity 124 from the outer surface of the cylindrical filter element 122, such that the water can be in full contact with the cylindrical filter element 122, and the cylindrical filter element 122 can fully filter the water. Filtered water is discharged through the filter element water outlet 128. A seal ring is arranged between the filter portion 12 and the base 11.

As shown in FIG. 1, the filter portion 12 further includes a vitamin C (VC) ball 125 arranged in the water outflow cavity 124. When the water flows through and comes into contact with the VC ball 125, the VC ball 125 can precipitate VC into the water, and purified water including the VC is obtained. In other embodiments, the cylindrical filter element can also include a rose essence ball or a lemon essential oil ball arranged in the water outflow cavity, and the rose essence ball and the lemon essential oil ball can also precipitate a skin-nourishing substance. The user can choose one or more of the VC ball, the rose essence ball and the lemon essential oil ball according to his/her own demands.

In addition, the cylindrical filter element 122 includes a carbon fiber adsorption layer 126. The carbon fiber adsorption layer 126 is made through wet carbon fiber technology and can remove odor, sediment, pigment, volatile organic compounds, etc., especially residual chlorine from the water. The cylindrical filter element 122 further includes a filter layer 127. Specifically, the filter layer 127 is a layered structure made from Ahlstrom Disruptor or polypropylene (PP) cotton. The filter layer 127 has a plurality of creases extending in the vertical direction, and the PP cotton can filter colloidal impurities, micro mud, rust, eggs, etc. with a larger diameter (for example, more than 5 micrometers in diameter) from the water. The filter portion 12 further includes a non-woven fabric layer arranged at the filter element water outlet 128 for further filtering the water.

In other embodiments, the cylindrical filter element further includes a filter structure, the filter structure is provided with a filter hole, and a diameter of the filter hole is less than or equal to 0.01 micrometers. Specifically, the filter structure includes a cylinder arranged in the water outflow cavity and a plurality of filter wires arranged in the cylinder, each filter wire has a channel penetrating in its length direction, a side wall of each filter wire is provided with a filter hole, and the plurality of filter wires extend in the same direction and are stacked together to form a bundle structure. The bundle structure is folded in half, such that channel outlets at two ends of all the filter wires extend in the same direction, and all the channel outlets are arranged on an end face of a first end of the cylinder. An end face or a side wall of a second end of the cylinder is provided with a water inlet, and a sealant is poured between an inner wall of the cylinder and portions, close to the first end, of the plurality of filter wires, to prevent water from flowing out of the cylinder from gaps between the plurality of filter wires or between the plurality of filter wires and the inner wall of the cylinder. After entering the cylinder from the water inlet, the water enters the channel through the filter hole, and then is discharged from the cylinder through the channel outlet. A diameter of the filter hole can be 0.007 micrometers, 0.009 micrometers or 0.01 micrometers. The filter structure can filter out harmful substances such as bacteria, rust and colloid from the water body, and retain original trace elements and minerals in the water body. In addition, the cylindrical filter element can further include a carbon fiber rod, and the carbon fiber rod is arranged in the water outflow cavity and located upstream of the filter structure and further adsorbs impurities from the water.

The user can choose one or more of the carbon fiber adsorption layer 126, the filter layer 127, the filter structure and the carbon fiber rod according to his/her own demands.

In addition, in this embodiment, the base 11 includes a pressing member, the filter portion 12 further includes a valve plate that is arranged at the filter element water outlet 128 and capable of blocking the filter element water outlet 128, and the pressing member is capable of pressing the valve plate, so as to implement communication between the water outlet and the water outflow cavity 124. Specifically, when the filter portion 12 is dismounted from the base 11, the valve plate blocks the filter element water outlet 128, to limit outflow of water from the water outflow cavity 124. When the filter portion 12 is mounted on the base 11, the pressing member presses the valve plate, to implement communication between the filter element water outflow channel 14 and the water outflow cavity 124.

In this embodiment, the filter portion 12 further includes a second check valve arranged at the filter element water inlet 129, and the second check valve is used for limiting outflow of water from the filter element water inlet 129. The second check valve enables water to flow from the filter element water inflow channel 13 into the water inflow cavity 123 through the filter element water inlet 129, and limits outflow of the water from the filter element water inlet 129. Thus, the water is prevented from flowing out from the filter portion 12 when the filter portion 12 is dismounted from the base 11.

As shown in FIGS. 1 and 6, the adapter structure 20 further includes a first flow channel 27 and a bypass valve 23 arranged in the first flow channel 27. The first flow channel 27 includes a water inflow channel 271, a water outflow channel 272 and a bypass channel 273, a first end of the water inflow channel 271 forms the raw water inlet 211, a first end of the bypass channel 273 forms the raw water outlet 212, and the bypass valve 23 is arranged at a junction of a second end of the water inflow channel 271, a second end of the bypass channel 273 and a first end of the water outflow channel 272. The bypass valve 23 has a purified water state and a raw water state, and when the bypass valve 23 is in the purified water state, the bypass valve 23 is capable of implementing communication between the water inflow channel 271 and the bypass channel 273 and blocking the water outflow channel 272. When the bypass valve 23 is in the raw water state, the bypass valve 23 is capable of implementing communication between the water inflow channel 271 and the water outflow channel 272 and blocking the bypass channel 273.

Specifically, the adapter structure 20 has a cylindrical structure arranged in the vertical direction. The raw water inlet 211 is located at an upper end face of the adapter structure 20, and the raw water outlet 212 is located at a side surface of the adapter structure 20. The bypass valve 23 includes a valve core rotatable relative to the adapter structure 20, and the valve core has a flow channel. The adapter structure 20 further includes an operation handle 24, the operation handle 24 penetrates the adapter structure 20 and is connected with the valve core, to control the bypass valve 23 to be switched between the purified water state and the raw water state. The user drives the operation handle 24 to rotate, to drive the bypass valve 23 to rotate. The flow channel of the valve core is T-shaped, a first opening of the flow channel is opposite the second opening, and the remaining opening is the third opening. When the bypass valve 23 is in the purified water state, the water outflow channel 272 is blocked by the valve core, the first opening of the flow channel is arranged corresponding to an inner wall of the adapter structure 20, the second opening of the flow channel is arranged corresponding to the raw water outlet 212, and the third opening of the flow channel is arranged corresponding to the raw water inlet 211, such that the flow channel implements communication between the water inflow channel 271 and the bypass channel 273, and then implements communication between the raw water inlet 211 and the raw water outlet 212, and water can enter the filter portion 12 to be filtered. When the bypass valve 23 is in the raw water state, the bypass channel 273 is blocked by the valve core, the first opening of the flow channel is arranged corresponding to the water outflow channel 272, the second opening of the flow channel is arranged corresponding to the raw water inlet 211, and the third opening of the flow channel is arranged corresponding to the inner wall of the adapter structure 20, such that the flow channel implements communication between the water inflow channel 271 and the water outflow channel 272, and the water is directly discharged from the water outflow channel 272.

As shown in FIGS. 1 and 6, in this embodiment, the adapter structure 20 further includes a second flow channel 28, the second flow channel 28 implements communication among a second end of the water outflow channel 272, the filtered water inlet 221 and the first adapter water outlet 222, and the base 11 includes a first check valve 112 arranged at the water outlet, so as to limit inflow of water into the filtration device 10 through the water outlet.

Specifically, when the bypass valve 23 is in the purified water state, water flows into the filter portion 12, and then into the second flow channel 28 from the filtered water inlet 221. Since the water outflow channel 272 is blocked by the valve core, the water can be only discharged from the first adapter water outlet 222, and thus the user can obtain filtered bubbly water from the faucet 40. When the bypass valve 23 is in the raw water state, water enters the second flow channel 28 through the water outflow channel 272. Since the first check valve 112 is arranged at the water outlet, the first check valve 112 allows the water to flow from the filter element water outflow channel 14 to the second diversion pipe 60 and limits flow of the water from the second diversion pipe 60 to the filter element water outflow channel 14, such that inflow of the water into the filter portion 12 is limited, the water can be only discharged from the first adapter water outlet 222, and the user obtains unfiltered bubbly water from the faucet 40.

As shown in FIG. 1, a bottom of the base 11 is provided with a suction cup 111. When the filter assembly is placed on a bearing platform, the suction cup 111 enables the base 11 to be stably connected with the bearing platform.

In addition, in this embodiment, the filtration device 10 further includes a pressure measurer, a temperature measurer and a display device, the pressure measurer and the temperature measurer are arranged at the water outlet, and the display device is arranged on an outer surface of the base 11 and is electrically connected with the pressure measurer and the temperature measurer. The pressure measurer can measure a water pressure at the water outlet, the temperature measurer can measure a water temperature at the water outlet, measured water temperature and water pressure data can be transmitted to the display device, and the display device shows the water pressure and water temperature to the user. The display device can be a display panel or a lamp ring, and the lamp ring can emit different colors of light, and different colors of light can correspond to different water pressures or water temperatures.

In this embodiment, the filtration device 10 further includes a power interface and a power module, the power module is arranged in the base 11, and the power interface is arranged on the outer surface of the base 11 and is electrically connected with the power module. The power interface is a Type-c interface, the power interface is used for charging the power module, and the power module provides electric energy for the pressure measurer, the temperature measurer, the display device, the lamp ring and other electrical structures in the filter assembly.

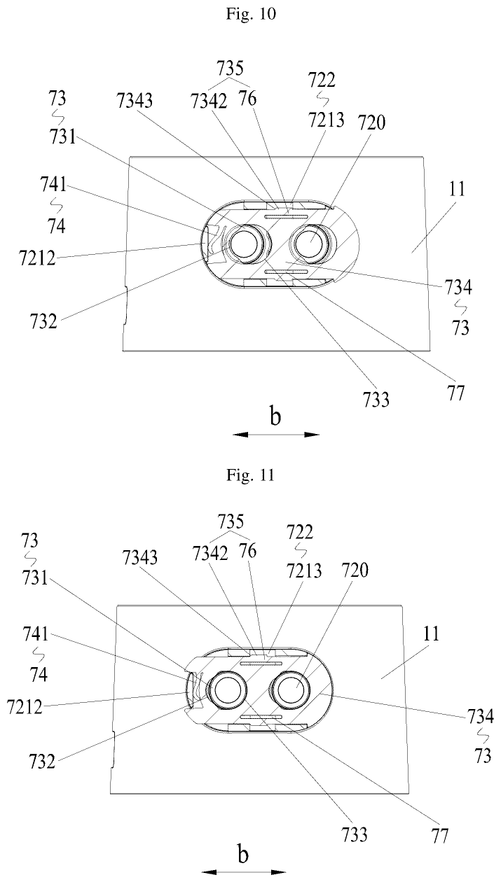

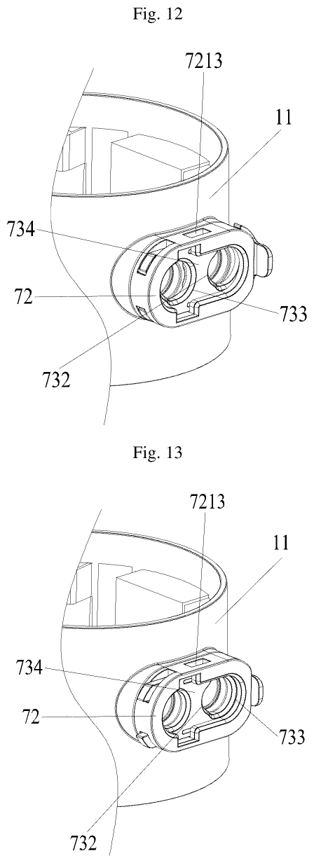

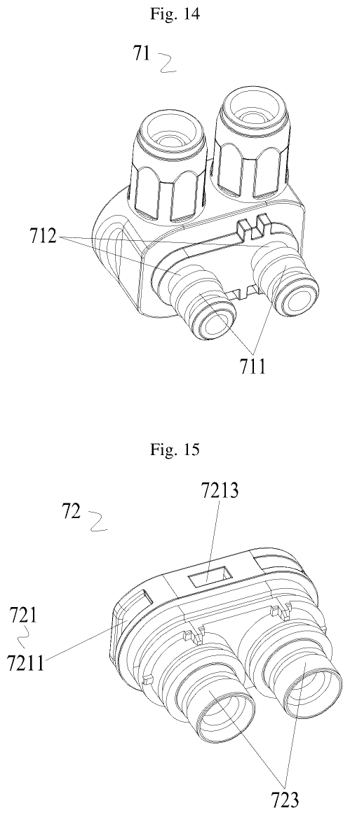

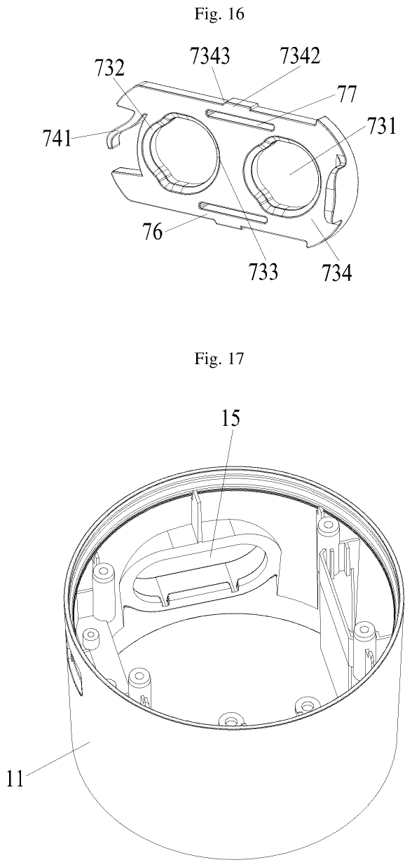

As shown in FIGS. 10-16, the filter assembly further includes a connection assembly arranged between the filtration device 10 and the adapter structure 20. The connection assembly implements communication between the raw water outlet 212 and the water inlet and communication between the filtered water inlet 221 and the water outlet, and the connection assembly includes a connection member 71, a mounting seat body 72 and a limiting member 73. The connection member 71 includes two connection pipe bodies 711, and the two connection pipe bodies 711 are in communication with the raw water outlet 212 and the filtered water inlet 221 respectively. The mounting seat body 72 is arranged on the filtration device 10 and is provided with a mounting seat body hole 720 penetrating the mounting seat body 72. The limiting member 73 is movably arranged on the mounting seat body 72 in a preset direction b and is provided with a limiting member hole 731 corresponding to the mounting seat body hole 720, the two connection pipe bodies 711 are inserted in the mounting seat body hole 720 and the limiting member hole 731, and the limiting member 73 has a limiting position and a mounting and dismounting position. When the limiting member 73 is located at the limiting position, the limiting member hole 731 is in limit fit with the connection pipe body 711, so as to prevent the connection pipe body 711 from being separated from the limiting member hole 731. When the limiting member 73 is in the mounting and dismounting position, the connection pipe body 711 is capable of being separated from the limiting member hole 731. The preset direction b is arranged at an angle relative to an axis of the mounting seat body hole 720.

Specifically, a hole wall of the limiting member hole 731 is provided with a first cambered segment 732 and a second cambered segment 733, a radius of the first cambered segment 732 is less than or equal to a radius of an outer surface of the connection pipe body 711, and a radius of the second cambered segment 733 is greater than the radius of the outer surface of the connection pipe body 711. When the limiting member 73 is located at the limiting position, the first cambered segment 732 is in limit fit with the connection pipe body 711, so as to prevent the connection pipe body 711 from being separated from the limiting member hole 731. When the limiting member 73 is located at the mounting and dismounting position, the second cambered segment 733 cooperates with the connection pipe body 711, so as to enable the connection pipe body 711 to be separated from the limiting member hole 731.

Specifically, the connection pipe body 711 includes a first pipe body and a second pipe body. The first pipe body is in communication with the raw water outlet 212 and the second pipe body is in communication with the filtered water inlet 221. The mounting seat body 72 is provided with the mounting seat body hole 720, and the mounting seat body hole 720 includes a first hole and a second hole. The limiting member 73 is provided with the limiting member hole 731, and the limiting member hole 731 includes a third hole and a fourth hole. The mounting seat body hole 720 is provided corresponding to the limiting member hole 731, that is, the first hole is arranged corresponding to the third hole, and the second hole is arranged corresponding to the fourth hole. The first pipe body can be inserted in the first hole and the third hole, and the second pipe body can be inserted in the second hole and the fourth hole. The limiting member 73 can move in the preset direction b, such that the limiting member 73 can be switched between the limiting position and the mounting and dismounting position. When it is necessary to connect the connection member 71 and the mounting seat body 72, the limiting member 73 is located at the mounting and dismounting position first, such that the connection pipe body 711 can be inserted into the mounting seat body hole 720 and the limiting member hole 731. Then, the limiting member 73 is switched to the limiting position, and since the radius of the first cambered segment 732 is less than or equal to the radius of the outer surface of the connection pipe body 711, the first cambered segment 732 can be in limit fit with the connection pipe body 711, the connection pipe body 711 will not be separated from the limiting member hole 731, and the connection member 71 is stably connected with the mounting seat body 72. When it is necessary to separate the connection member 71 from the mounting seat body 72, the limiting member 73 is switched from the limiting position to the mounting and dismounting position. Since the radius of the second cambered segment 733 is greater than the radius of the outer surface of the connection pipe body 711, the connection pipe body 711 can be separated from the limiting member hole 731, and the connection member 71 can be separated from the mounting seat body 72. The user can switch the limiting member 73 between the limiting position and the mounting and dismounting position by only moving the limiting member 73 in the preset direction b, the connection member 71 and the mounting seat body 72 are connected with and separated from each other, operations of the user to connect the connection member 71 with the mounting seat body 72 or separate the connection member from the mounting seat body are simplified, and the user experience is improved.

It should be noted that in this embodiment, the “preset direction b” refers to the left-right direction in FIGS. 10 and 11, and the preset direction b is perpendicular to the axis of the mounting seat body hole 720.

As shown in FIGS. 10-16, the mounting seat body 72 includes a mounting recess 721 extending in the preset direction b, and the limiting member 73 includes an insertion plate 734 movably arranged in the mounting recess 721. The limiting member hole 731 is provided on the insertion plate 734, and a limiting recess 712 is provided on the connection member 71. When the limiting member 73 is located at the limiting position, at least part, corresponding to the first cambered segment 732, of the insertion plate 734 extends into the limiting recess 712, so as to prevent the connection pipe body 711 from being separated from the limiting member hole 731. Specifically, the mounting recess 721 extends in the preset direction b, and the insertion plate 734 is arranged in the mounting recess 721, such that the limiting member 73 can move in the preset direction b. The limiting recess 712 is an annular recess provided on an outer side wall of the connection pipe body 711. When the limiting member 73 is at the limiting position, the at least part, corresponding to the first cambered segment 732, of the insertion plate 734 extends into the limiting recess 712, and this part of the insertion plate 734 is in stop fit with the side wall of the limiting recess 712, such that the connection pipe body 711 will not be separated from the limiting member hole 731. When the limiting member 73 is at the mounting and dismounting position, a projection of the connection pipe body 711 on the insertion plate 734 is completely within a range of the limiting member hole 731, the insertion plate 734 does not extend into the limiting recess 712, and the connection pipe body 711 can be separated from the limiting member hole 731.

It should be noted that in this embodiment, the fact that “the radius of the first cambered segment 732 is less than or equal to the radius of the outer surface of the connection pipe body 711” indicates that the radius of the first cambered segment 732 is less than or equal to a distance from an opening of the limiting recess 712 to an axis of the connection pipe body 711. The fact that “the radius of the second cambered segment 733 is greater than the radius of the outer surface of the connection pipe body 711” indicates that the radius of the second cambered segment 733 is greater than a maximum radius of the outer surface of the connection pipe body 711.

The connection assembly further includes a retainer 74 arranged between the mounting seat body 72 and the limiting member 73, and the retainer 74 is capable of cooperating with the limiting member 73, so as to retain the limiting member 73 at the limiting position. Specifically, the retainer 74 can retain the limiting member 73 at the limiting position, thus guaranteeing that the connection member 71 is stably connected with the mounting seat body 72.

As shown in FIGS. 10-16, the mounting recess 721 is provided with a mounting opening 7211 and a recess bottom wall 7212 opposite the mounting opening 7211. The retainer 74 includes a first elastic arm 741 arranged on the insertion plate 734. The first elastic arm 741 is in pressing fit with the recess bottom wall 7212, to exert pressing force towards the mounting opening 7211 on the insertion plate 734, and the first cambered segment 732 is closer to the first elastic arm 741 relative to the second cambered segment 733. Specifically, the insertion plate 734 is inserted into the mounting recess 721 from the mounting opening 7211. As shown in FIG. 10, the limiting member 73 is at the limiting position, the first elastic arm 741 is in pressing fit with the recess bottom wall 7212, and the first elastic arm 741 exerts horizontal rightward force on the insertion plate 734, such that part of the insertion plate 734 can be in stop fit with the side wall of the limiting recess 712 stably. The user exerts a horizontal leftward thrust on the insertion plate 734, and the insertion plate 734 moves horizontally leftwards from a position in FIG. 10 to a position in FIG. 11. As shown in FIG. 11, the limiting member 73 is at the mounting and dismounting position, and the first elastic arm 741 is further compressed. When the user release the thrust, the first elastic arm 741 can push the insertion plate 734 horizontally rightwards, such that part of the insertion plate 734 extends into the limiting recess 712 and the limiting member 73 is retained at the limiting position. The first clastic arm 741 has a simple structure and is easy to machine.

As shown in FIGS. 10-16, the mounting seat body 72 includes a mounting seat body stop portion 722, an insertion plate stop portion 735 is arranged on the insertion plate 734, and the mounting seat body stop portion 722 is in stop fit with the insertion plate stop portion 735, so as to prevent the insertion plate 734 from being separated from the mounting recess 721. In this embodiment, the insertion plate stop portion 735 includes a second elastic arm 76 arranged on the insertion plate 734 and a stop block 7342 arranged on the second elastic arm 76. The mounting seat body stop portion 722 includes a stop recess 7213 provided on a side wall of the mounting recess 721, and the stop block 7342 is movably arranged in the stop recess 7213 in the preset direction b, such that the limiting member 73 can move between the limiting position and the mounting and dismounting position.

Specifically, the stop recess 7213 is a through recess that extends in a direction perpendicular to the preset direction b and penetrates the mounting seat body 72, and is easy to machine. The stop block 7342 is arranged at a side, far away from the insertion plate 734, of the second clastic arm 76, an avoiding recess 77 is provided between the second elastic arm 76 and the insertion plate 734, and two ends of the second elastic arm 76 are connected with the insertion plate 734. A side, far away from the mounting opening 7211, of the stop block 7342 is provided with a guide slope 7343. When the insertion plate 734 is inserted into the mounting recess 721, the side wall of the mounting recess 721 cooperates with the guide slope 7343, such that the stop block 7342 moves in a direction close to the insertion plate 734. The insertion plate 734 continues to move in the horizontal left direction in FIG. 10. When the stop block 7342 is located at a position of the stop recess 7213, the second elastic arm 76 returns to a natural state, such that the stop block 7342 moves away from the insertion plate 734, a side wall, close to the mounting opening 7211, of the stop block 7342 can be in stop fit with the side wall of the stop recess 7213, and the insertion plate 734 will not be separated from the mounting recess 721. The stop recess 7213 has a width in the preset direction b, such that the stop block 7342 can move in the stop recess 7213 in the preset direction b, and the limiting member 73 can move between the limiting position and the mounting and dismounting position.

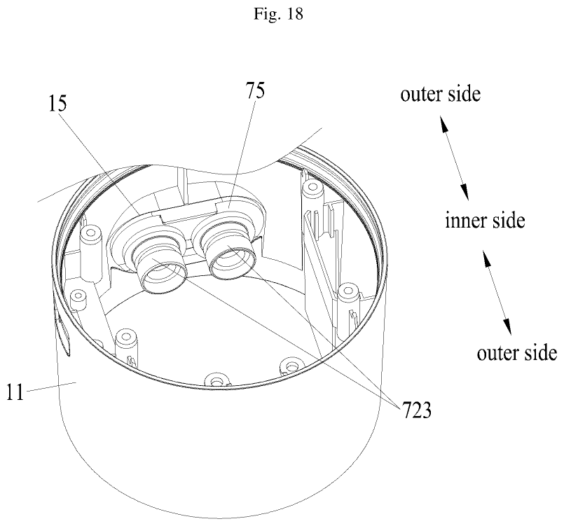

As shown in FIGS. 17 and 18, a mounting opening 15 is provided on the base 11, and the mounting seat body 72 is inserted in the mounting opening 15. The mounting seat body 72 includes two adapter pipes 723 corresponding to the two connection pipe bodies 711, a first end of each adapter pipe 723 is in communication with a corresponding connection pipe body 711, a second end of one adapter pipe 723 of the two adapter pipes 723 is in communication with the water inlet, a second end of the other adapter pipe 723 is in communication with the water outlet, and at least part of the adapter pipe 723 is located at an inner side of the base 11. The filter assembly further includes a lock member 75 arranged at the inner side of the base 11, and the lock member 75 is connected with the adapter pipe 723, so as to prevent the mounting seat body 72 from being separated outwards from the base 11.

Specifically, the mounting opening 15 is arranged on the base 11, and the adapter pipe 723 includes a third pipe body and a fourth pipe body. A first end of the third pipe body is in communication with the first pipe body, a second end of the third pipe body forms the water inlet, a first end of the fourth pipe body is in communication with the second pipe body, and a second end of the fourth pipe body forms the water outlet, such that the adapter structure 20 is in communication with the filtration device 10. The lock member 75 includes a lock plate and two incomplete circular holes provided on the lock plate. An opening is provided between the circular hole and a side wall of the lock plate, and a central angle between the opening and a center of the circular hole is an acute angle. One circular hole fits with an outer contour of one adapter pipe 723. When the lock member is mounted with the adapter pipe 723, part, corresponding to the lock plate, of the circular hole far away from the other circular hole can be elastically deformed in a direction far away from the other circular hole, such that the adapter pipe 723 can be squeezed into the circular hole. The lock member 75 has a simple structure.

It should be noted that the housing 121 has a cylindrical structure. As shown in FIG. 18, “the inner side of the base 11” refers to space defined by the cylindrical structure, and “the outer side of the base 11” refers to space outside the cylindrical structure.

In addition, as shown in FIG. 7, the disclosure further provides a second embodiment of the filter assembly. The second embodiment of the filter assembly is mainly different from the first embodiment in that a specific structure of the adapter structure 20 is different. Specifically, in the second embodiment, the adapter structure 20 further includes a second flow channel 28. The adapter structure 20 further includes a second adapter water outlet 224, and the second flow channel 28 further includes a first channel and a second channel that are separated from each other. The first channel implements communication between the filtered water inlet 221 and the first adapter water outlet 222, and the second channel implements communication between a second end of the water outflow channel 272 and the second adapter water outlet 224.

Specifically, in this embodiment, when the bypass valve 23 is in the purified water state, water flows into the filter portion 12, and then into the first channel from the filtered water inlet 221. The water can be only discharged from the first adapter water outlet 222, and thus the user can obtain filtered bubbly water from the faucet 40. When the bypass valve 23 is in the raw water state, water enters the second channel through the water outflow channel 272, the water can be only discharged from the second adapter water outlet 224, and the user obtains unfiltered raw water from the lower end of the adapter structure 20.

The embodiments are merely preferred embodiments of the disclosure and are not intended to limit the disclosure, and various modifications and changes on the disclosure can be made by those skilled in the art. Any modification, equivalent substitution, improvement, etc. made within the spirit and principles of the disclosure should fall within the protection scope of the disclosure.

1. A filter assembly, comprising:
a filtration device, wherein the filtration device comprises a base and a filter portion arranged on the base, and a water inlet and a water outlet are provided on the base;
an adapter structure, wherein the adapter structure is provided with a raw water inlet, a raw water outlet, a filtered water inlet and a first adapter water outlet; the raw water inlet is capable of being in communication with an external water source, the raw water outlet is in communication with the water inlet, and the filtered water inlet is in communication with the water outlet; and the raw water inlet is in communication with the raw water outlet, and the filtered water inlet is in communication with the first adapter water outlet;
a rocker arm structure, wherein the rocker arm structure is provided with a connecting channel in communication with the first adapter water outlet, and a first end of the rocker arm structure is swingably connected with the first adapter water outlet; and
a faucet, wherein the faucet is connected with a second end of the rocker arm structure and in communication with the connecting channel.

2. The filter assembly according to claim 1, wherein the faucet comprises a faucet body and a connection pipe, the faucet body is arranged at a first end of the connection pipe and is arranged at an angle relative to the connection pipe, and a second end of the connection pipe is rotatably connected with the second end of the rocker arm structure and the connection pipe is arranged at an angle relative to the rocker arm structure.

3. The filter assembly according to claim 2, wherein the rocker arm structure comprises a rocker arm body, a first rotary connecting portion arranged at a first end of the rocker arm body and a second rotary connecting portion arranged at a second end of the rocker arm body, and each of the first rotary connecting portion and second rotary connecting portion is arranged at an angle relative to the rocker arm body.

4. The filter assembly according to claim 3, wherein the adapter structure comprises a third rotary connecting portion arranged at the first adapter water outlet, the first rotary connecting portion is rotatably nested with the third rotary connecting portion, and the second rotary connecting portion is rotatably nested with the second end of the connection pipe.

5. The filter assembly according to claim 3, wherein the faucet further comprises a ball joint connection part, and the faucet body is rotatably connected with the connection pipe through the ball joint connection part.

6. The filter assembly according to claim 1, wherein the faucet further comprises a bubble generator connected with the second end of the rocker arm structure.

7. The filter assembly according to claim 1, wherein the filter portion is detachably arranged on the base, the filter portion comprises a housing and a cylindrical filter element arranged in the housing, a water inflow cavity in communication with the water inlet is formed between an outer surface of the cylindrical filter element and the housing, and a water outflow cavity in communication with the water outlet is formed inside the cylindrical filter element.

8. The filter assembly according to claim 7, wherein
the filter portion further comprises a vitamin C (VC) ball arranged in the water outflow cavity; and/or,
the cylindrical filter element comprises a carbon fiber adsorption layer; and/or,
the cylindrical filter element comprises a filter structure, the filter structure is provided with a filter hole, and a diameter of the filter hole is less than or equal to 0.01 micrometers.

9. The filter assembly according to claim 7, wherein the adapter structure further comprises a first flow channel and a bypass valve arranged in the first flow channel; the first flow channel comprises a water inflow channel, a water outflow channel and a bypass channel, a first end of the water inflow channel forms the raw water inlet, a first end of the bypass channel forms the raw water outlet, and the bypass valve is arranged at a junction of a second end of the water inflow channel, a second end of the bypass channel and a first end of the water outflow channel; the bypass valve has a purified water state and a raw water state, and when the bypass valve is in the purified water state, the bypass valve is capable of implementing communication between the water inflow channel and the bypass channel and blocking the water outflow channel; and when the bypass valve is in the raw water state, the bypass valve is capable of implementing communication between the water inflow channel and the water outflow channel and blocking the bypass channel.

10. The filter assembly according to claim 9, wherein the adapter structure further comprises a second flow channel, the second flow channel implements communication among a second end of the water outflow channel, the filtered water inlet and the first adapter water outlet, and the base comprises a first check valve arranged at the water outlet, so as to limit inflow of water into the filtration device through the water outlet.

11. The filter assembly according to claim 9, wherein the adapter structure further comprises a second flow channel; the adapter structure further comprises a second adapter water outlet, and the second flow channel comprises a first channel and a second channel that are separated from each other; and the first channel implements communication between the filtered water inlet and the first adapter water outlet, and the second channel implements communication between a second end of the water outflow channel and the second adapter water outlet.

12. The filter assembly according to claim 7, wherein the base comprises a pressing member, the filter portion further comprises a filter element water outlet in communication with the water outflow cavity and a valve plate that is arranged at the filter element water outlet and capable of blocking the filter element water outlet, and the pressing member is capable of pressing the valve plate, so as to implement communication between the water outlet and the water outflow cavity.

13. The filter assembly according to claim 7, wherein the filter portion further comprises a filter element water inlet in communication with the water inflow cavity and a second check valve arranged at the filter element water inlet, and the second check valve is used for limiting outflow of water from the filter element water inlet.

14. The filter assembly according to claim 1, wherein
the filtration device further comprises a pressure measurer, a temperature measurer and a display device, the pressure measurer and the temperature measurer are arranged at the water outlet, and the display device is arranged on an outer surface of the base and is electrically connected with the pressure measurer and the temperature measurer; and/or,
the filtration device further comprises a power interface and a power module, the power module is arranged in the base, and the power interface is arranged on an outer surface of the base and is electrically connected with the power module.

15. The filter assembly according to claim 1, further comprising a connection assembly arranged between the filtration device and the adapter structure, wherein the connection assembly implements communication between the raw water outlet and the water inlet and communication between the filtered water inlet and the water outlet, and the connection assembly comprises a connection member, a mounting seat body and a limiting member;
the connection member comprises two connection pipe bodies, and the two connection pipe bodies are in communication with the raw water outlet and the filtered water inlet respectively;
the mounting seat body is arranged on the filtration device and is provided with a mounting seat body hole penetrating the mounting seat body; and
the limiting member is movably arranged on the mounting seat body in a preset direction and is provided with a limiting member hole corresponding to the mounting seat body hole, the two connection pipe bodies are inserted in the mounting seat body hole and the limiting member hole, and the limiting member has a limiting position and a mounting and dismounting position; when the limiting member is located at the limiting position, the limiting member hole is in limit fit with the connection pipe body, so as to prevent the connection pipe body from being separated from the limiting member hole; and when the limiting member is at the mounting and dismounting position, the connection pipe body is capable of being separated from the limiting member hole, wherein the preset direction is arranged at an angle relative to an axis of the mounting seat body hole.

16. The filter assembly according to claim 15, wherein a hole wall of the limiting member hole is provided with a first cambered segment and a second cambered segment, a radius of the first cambered segment is less than or equal to a radius of an outer surface of the connection pipe body, and a radius of the second cambered segment is greater than the radius of the outer surface of the connection pipe body; when the limiting member is located at the limiting position, the first cambered segment is in limit fit with the connection pipe body, so as to prevent the connection pipe body from being separated from the limiting member hole; and when the limiting member is located at the mounting and dismounting position, the second cambered segment cooperates with the connection pipe body, so as to enable the connection pipe body to be separated from the limiting member hole.

17. The filter assembly according to claim 16, wherein the mounting seat body comprises a mounting recess extending in the preset direction, and the limiting member comprises an insertion plate movably arranged in the mounting recess; the limiting member hole is provided on the insertion plate, and a limiting recess is provided on the connection member; and when the limiting member is located at the limiting position, at least part, corresponding to the first cambered segment, of the insertion plate extends into the limiting recess, so as to prevent the connection pipe body from being separated from the limiting member hole.

18. The filter assembly according to claim 16, wherein the connection assembly further comprises a retainer arranged between the mounting seat body and the limiting member, and the retainer is capable of cooperating with the limiting member, so as to retain the limiting member at the limiting position.

19. The filter assembly according to claim 17, wherein the mounting seat body comprises a mounting seat body stop portion, an insertion plate stop portion is arranged on the insertion plate, and the mounting seat body stop portion is in stop fit with the insertion plate stop portion, so as to prevent the insertion plate from being separated from the mounting recess.

20. The filter assembly according to claim 16, wherein a mounting opening is provided on the base, and the mounting seat body is inserted in the mounting opening; the mounting seat body comprises two adapter pipes corresponding to the two connection pipe bodies, a first end of each adapter pipe is in communication with a corresponding connection pipe body, a second end of one adapter pipe of the two adapter pipes is in communication with the water inlet, a second end of the other adapter pipe is in communication with the water outlet, and at least part of the adapter pipe is located at an inner side of the base; and the filter assembly further comprises a lock member arranged at the inner side of the base, and the lock member is connected with the adapter pipe, so as to prevent the mounting seat body from being separated outwards from the base.
